(19) United States
(12) Patent Application Publication
(10) Pub. No.: US 2020/0165998 A1
(43) Pub. Date: May 28, 2020

(54) Flow Volume Control Device, and Method for Manufacturing Flow Volume Control Device

(71) Applicant: Hitachi Automotive Systems, Ltd., Hitachinaka-shi, Ibaraki (JP)

(72) Inventors: Takao MIYAKE, Hitachinaka (JP); Masaru KAWAI, Hitachinaka (JP); Masashi SUGAYA, Hitachinaka (JP); Yasuo NAMAIZAWA, Hitachinaka (JP)

(21) Appl. No.: 16/629,489

(22) PCT Filed: Jul. 17, 2018
(86) PCT No.: PCT/JP2018/026646

§ 371 Date: Jan. 8, 2020

(30) Foreign Application Priority Data
Sep. 12, 2017 (JP) 2017-175231

(51) Int. Cl. F02D 41/38; F02M 51/06

(52) U.S. Cl. CPC F02D 41/38; H01F 7/1607; F02M 51/0614

(57) ABSTRACT

Provided are a flow volume control device capable of securing a strength withstanding a high fuel pressure, and a method for manufacturing the flow volume control device. A fuel injection valve 1 includes a movable element 102 and a nozzle holder 101 that is positioned on the outer peripheral side of the movable element 102 and holds the movable element 102 inside in a radial direction. The nozzle holder 101 is molded using precipitation hardening stainless steel as a material. In addition, the manufacturing method includes forging and molding a material by forging using the precipitation hardening stainless steel as the nozzle holder 101, performing solution thermal treatment on the material after the forging and molding step, and performing precipitation hardening thermal treatment on the material after the solution thermal treatment, and finishing and molding the material after the precipitation hardening thermal treatment.

### TECHNICAL FIELD

The present invention relates to a flow volume control device and a method for manufacturing the flow volume control device.

### BACKGROUND ART

PTL 1 discloses an electromagnetically operable valve, particularly for a fuel injection device of an internal combustion engine. The value includes a core surrounded by a magnet coil, a movable element which operates a valve closing body that cooperates with a stationary valve seat, and a tubular closure portion which is disposed on a downstream side of the core. The closure portion partially surrounds the movable element in a radial direction. The core and the closure portion are connected to each other such that a magnet can be passed directly through a magnetic throttle part. The core and the closure portion form an entire structure from one portion.

### CITATION LIST

### Patent Literature

PTL 1: JP 11-500509 A

### SUMMARY OF INVENTION

### Technical Problem

In recent years, it is requested that a flow volume control device such as a fuel injection valve used in an internal combustion engine and a high-pressure fuel pump that supplies pressurized fuel to the internal combustion engine equipped with the fuel injection valve have responded to higher fuel pressures in accordance with exhaust gas regulations.

In particular, recent exhaust gas regulations require that the amount and quantity of particulate matter contained in the exhaust gas be reduced. Even in a flow volume control device that uses gasoline, the normal maximum fuel pressure may increase to about 35 MPa. In a case where a normal maximum fuel pressure is 35 MPa, the fuel injection valve is required to hold the fuel up to, for example, 55 MPa.

If the fuel pressure increases, the pressure may cause a larger stress in the flow volume control device than before, and the margin for strength may be reduced.

In particular, in the flow volume control device with a built-in solenoid that opens and closes a fuel passage by a movable element that is electromagnetically driven, it is necessary to withstand a high fuel pressure, and a large magnetic attraction force is required in order to operate against this high fuel pressure.

In response to such a demand, a flow volume control device that is further improved from the technique described in PTL 1 is desired.

An object of the invention is to provide a flow volume control device capable of securing a strength withstanding a high fuel pressure, and a method for manufacturing the flow volume control device.

### Solution to Problem

The invention includes a plurality of means for solving the above problems. As an example, the flow volume control device includes a movable element, and a metal member that is positioned on an outer peripheral side of the movable element and holds the movable element inside in a radial direction. The metal member is molded using a precipitation hardening stainless steel as a material.

### Advantageous Effects of Invention

According to the invention, it is possible to secure strength that can withstand high fuel pressure. Objects, configurations, and effects besides the above description will be apparent through the explanation on the following embodiments.

### BRIEF DESCRIPTION OF DRAWINGS

FIG. 1 is a cross-sectional view of a part of a fuel injection valve and a fuel pipe according to an embodiment of a flow volume control device of the invention.

FIG. 2 is an enlarged cross-sectional view around a movable element of the fuel injection valve according to the embodiment.

FIG. 3 is a flowchart illustrating a manufacturing procedure of a nozzle holder of a fuel injection valve according to the embodiment.

FIG. 4 is a diagram illustrating a cross-sectional view and a forged line in the manufacturing procedure of the nozzle holder of the fuel injection valve according to the embodiment.

FIG. 5 is a diagram illustrating a cross-sectional view and a forged line in the manufacturing procedure of the nozzle holder of the fuel injection valve according to the embodiment.

FIG. 6 is a diagram illustrating a cross-sectional view and a forged line in the manufacturing procedure of the nozzle holder of the fuel injection valve according to the embodiment.

FIG. 7 is an enlarged cross-sectional view of a magnetic throttle part of the nozzle holder of the fuel injection valve according to the embodiment.

FIG. 8 is a diagram illustrating a cross-sectional view and a forged line in a manufacturing procedure of a nozzle holder of a fuel injection valve according to another embodiment of the embodiment.

FIG. 9 is a diagram illustrating a cross-sectional view and a forged line in the manufacturing procedure of a nozzle holder of a fuel injection valve according to another embodiment of the embodiment.

FIG. 10 is an enlarged cross-sectional view of a magnetic throttle part of a nozzle holder of a fuel injection valve according to another embodiment of the embodiment.

### DESCRIPTION OF EMBODIMENTS

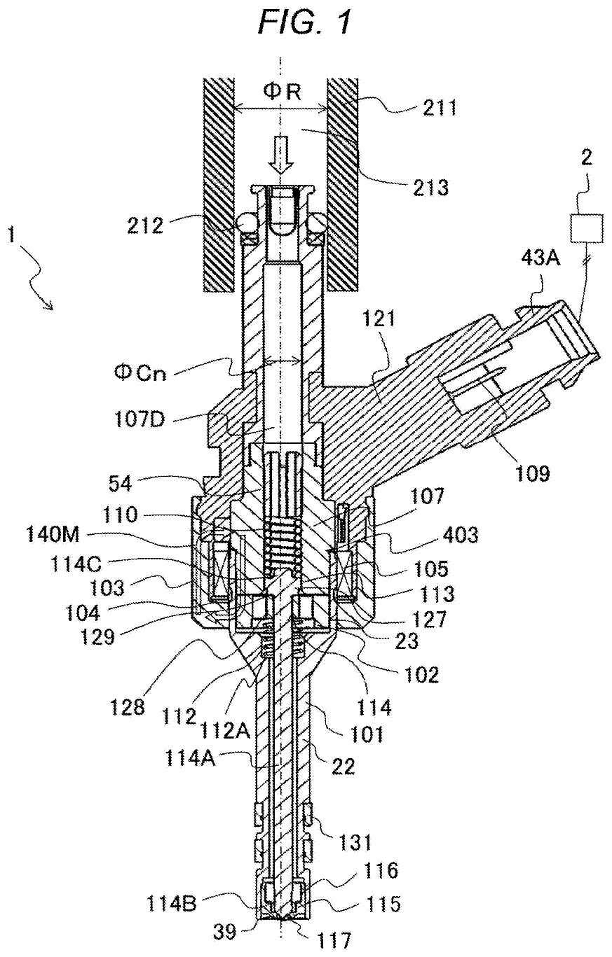

Configurations and operational effects of embodiments of a flow volume control device and a method for manufacturing the flow volume control device of the invention will be described with reference to FIGS. 1 to 10.

Further, in this embodiment, a fuel injection valve (fuel injection device) will be described as an example of the flow volume control device. However, the flow volume control device of the invention is not limited to the embodiments, and is applicable to, for example, a high-pressure fuel pump.

Further, in the drawings, the size of components and the size of gaps may be exaggerated from the actual ratio to make functions easy to understand, and unnecessary components may be omitted for the explanation of the functions.

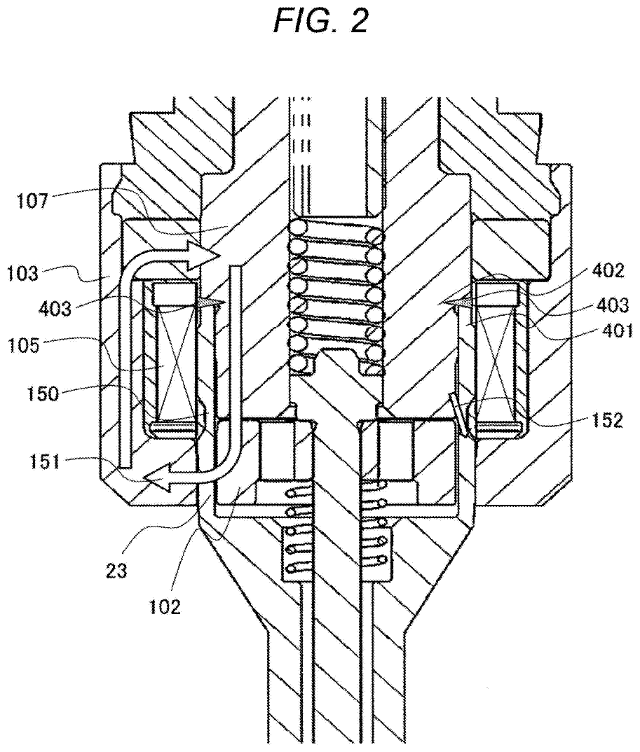

First, the outline of the configuration of the fuel injection valve according to this embodiment will be described with reference to FIGS. 1 and 2. FIG. 1 is a longitudinal cross-sectional view of the fuel injection valve and its peripheral structure according to this embodiment. FIG. 2 is an enlarged cross-sectional view around a movable element of the fuel injection valve.

An internal combustion engine includes a fuel injection control device 2 that performs a calculation for converting an appropriate fuel amount corresponding to an operating state into an injection time of the fuel injection valve, and drives the fuel injection valve which supplies fuel.

As illustrated in FIG. 1, a fuel injection valve 1 is configured by a movable element member 114 which includes a cylindrical movable element 102 and a needle valve (valve element) 114A positioned at the center of the movable element 102. A gap is provided between the end surface of a fixed core 107 having a fuel introduction hole for introducing fuel to the center and the end surface of the movable element 102, and on the outer peripheral side of the fixed core 107 and the movable element 102. An electromagnetic coil 105 (solenoid) for supplying a magnetic flux to a magnetic passage portion including the gap is provided. In other words, the fixed core 107 is disposed to face the upper end portion of the movable element 102 as illustrated in FIG. 1.

The movable element 102 is driven by a magnetic attraction force generated between the end surface of the movable element 102 and the end surface of the fixed core 107 by the magnetic flux passing through the gap to drive the movable element 102 toward the fixed core 107, and draws the needle valve 114A away from a valve seat portion 39 to open a fuel passage provided in the valve seat portion 39. In other words, the movable element 102 drives the needle valve 114A.

A core part of the fuel injection valve 1 is configured by two components, the fixed core 107 and a nozzle holder (metal member) 101. The nozzle holder 101 is made of a material having higher yield stress and tensile strength than the fixed core 107. The fixed core 107 is made of a material having excellent magnetic properties. These two components are press-fitted in the radial direction and then fixed by butt welding at a butt welded portion 403. With two components forming the core part, it is possible to easily satisfy various characteristics required for the core part.

As illustrated in FIG. 2, a magnetic flux 151 forms a closed circuit around the electromagnetic coil 105. The path is the fixed core 107, the movable element 102, a movable element storage portion 23 of the nozzle holder 101, and a housing 103.

A magnetic throttle part 150 is formed on the outer peripheral side of the movable element storage portion 23 of the nozzle holder 101, and has a smaller thickness than the periphery thereof. Such a magnetic throttle part 150 increases the magnetic attraction force acting between the fixed core 107 and the movable element 102 by reducing a magnetic flux 152 that does not pass through the movable element 102 and increasing the magnetic flux that passes through the movable element 102.

The amount of injected fuel is mainly determined by the pressure difference between the fuel pressure and the atmospheric pressure at the injection port of the fuel injection valve 1 and the time during which the fuel is injected while maintaining the needle valve 114A open.

When energization to the electromagnetic coil 105 is stopped, the magnetic attraction force acting on the movable element 102 disappears. The needle valve 114A and the movable element 102 move in a closing direction due to the pressure drop caused by the force of the spring 110 that biases the needle valve 114A in the closing direction and the flow rate of the fuel flowing between the needle valve 114A and the fixed core 107. When the needle valve 114A is seated on the valve seat portion 39, the fuel passage is closed. The fuel is sealed by the contact between the needle valve 114A and the valve seat portion 39, and the fuel is prevented from leaking from the fuel injection valve 1 at an unintended timing.

In recent years, from the viewpoint of reducing fuel consumption, attempts have been made to reduce the amount of fuel consumed when a vehicle is mounted by reducing the displacement of the internal combustion engine in combination with a supercharger and using a heat-efficient operating region. This attempt is particularly effective when combined with an in-cylinder direct injection internal combustion engine that is expected to improve the intake air filling amount by vaporizing the fuel and to improve a knock resistance characteristic.

In addition, since a large reduction in fuel consumption is required in a wide range of vehicles, demand for an in-cylinder direct injection type of internal combustion engine increases. Further, there is a need to mount other devices that are effective in reducing fuel consumption, such as recovery of regenerative energy, are used in automobiles. In addition, cost reduction of various devices is demanded from the viewpoint of reducing the total cost, and the cost reduction demand for the fuel injection valve 1 for in-cylinder direct injection is also increasing.

On the other hand, it is also required to further reduce the components contained in the exhaust gas of the internal combustion engine. Particularly, from the viewpoint of reducing the amount and quantity of particulate matter, attempts have been made to increase the fuel injection pressure from the conventional 20 MPa to about 35 MPa for example to reduce a droplet diameter of the injected fuel and to promote vaporization.

The upper part of FIG. 1 schematically illustrates a load applied in the axial direction of the fuel injection valve 1 by the fuel pressure. Since the fuel injection valve 1 is connected to a fuel pipe 211 and the fuel is sealed by the O-ring 212, the fuel pipe interior 213 and the interior of the fuel injection valve 1 are filled with high-pressure fuel.

When the fuel pressure is increased, the stress generated in the member that holds the internal fuel pressure with respect to the outside of the fuel injection valve 1 increases. In order to provide a margin of strength against stress generated at high fuel pressure, it is necessary to increase the thickness to ensure rigidity or to use a material having high strength.

However, as described above, the magnetic throttle part 150 reduces the magnetic flux 152 that does not pass through the movable element 102 by reducing the thickness, and increases the magnetic flux that passes through the movable element 102, thereby increasing the magnetic attraction force between the fixed core 107 and the movable element 102. Therefore, it is difficult to increase the wall thickness. Therefore, in order to maintain a margin for strength even at high stress, it is effective to select a material having high yield stress and tensile strength.

On the other hand, it is possible to use the magnetic throttle part 150 as a separate member and use a material having high strength only for the magnetic throttle part 150. However, in this case, the magnetic throttle part 150 is bonded to the movable element storage portion 23 of the nozzle holder 101. Therefore, there is a concern that the strength of the bonded portion may be reduced and the cost may be increased.

Similarly, it is possible to increase the wall thickness by using the magnetic throttle part 150 as a separate member and using a non-magnetic material only for the magnetic throttle part 150. However, in that case, the magnetic throttle part 150 is necessarily bonded to the movable element storage portion 23 of the nozzle holder 101. Therefore, there is a concern that the strength of the bonded portion may be reduced and the cost may be increased.

In a case where the nozzle holder 101 is entirely cut out from the bar, the amount of processing is large, waste of materials and waste of processing time occur, and it is difficult to reduce the cost. In addition, a material having high strength is generally difficult to process, and the processing time is extended. Therefore, it is difficult to reduce the cost.

Therefore, in the invention, a component called a blank material close to the shape of the final nozzle holder 101 is manufactured by forging rod-like stainless steel, particularly by cold forging. Thereafter, the nozzle holder 101 is manufactured with the minimum necessary processing by performing various thermal treatments and finishing on the blank material. Further, by integrating the movable element storage portion 23 and the magnetic throttle part 150 into the nozzle holder 101, useless bonded portions are reduced, and the strength can be maintained.

As described above, since the nozzle holder 101 includes the movable element storage portion 23, it is necessary to pass the magnetic flux to the movable element 102 as illustrated in FIG. 2, and the material is necessarily magnetized. As described above, in order to generate a high magnetic attraction force on the movable element 102 and the fixed core 107, it is necessary to reduce the magnetic flux 152 flowing from the fixed core 107 to the movable element storage portion 23 without passing through the movable element 102. For this reason, it is necessary to make the magnetic throttle part 150 thin.

Here, when the magnetic throttle part 150 is thinned, a probability that the strength is lowered due to inclusions (components other than stainless steel) generally existing in the stainless steel material increases.

Therefore, in this embodiment, as a material of the nozzle holder 101 in which the magnetic throttle part 150 is formed, a precipitation hardening stainless steel having magnetic, high strength, and high corrosion resistance is used. In particular, a rod material made of stainless steel equivalent to JIS-SUS630 (17-4PH, etc.) or a rod material made of stainless steel equivalent to JIS-SUS631 (17-7PH, etc.) are preferably used.

Then, after annealing this precipitation hardening stainless steel, cold-forging is performed along the shape of the movable element storage portion 23 and the magnetic throttle part 150 to produce a blank material. Among these, the magnetic throttle part 150 is molded on the outer peripheral side of the intermediate portion between the movable element 102 and the fixed core 107.

Thereafter, by performing a solution thermal treatment, distortion of the metal structure during cold forging is removed. In particular, the magnetic properties of the movable element storage portion 23 are improved. Thereafter, precipitation hardening thermal treatment is performed to improve strength.

Finally, the entire inner circumference of the nozzle holder 101 (molds the spring storage portion 112A, and also molds a space for inserting the needle valve 114A and an injection hole cup 116) and the entire outer circumference (the magnetic throttle part 150 and a groove holding a chip seal 131) are cut to be finished. With respect to the magnetic throttle part 150, the thickness thereof is set to make the magnetic flux 152 leaking from the fixed core 107 to the movable element storage portion 23 sufficiently small so as to improve the magnetic attraction force.

Through the above procedures, it is possible to provide the fuel injection valve 1 capable of realizing high strength and high magnetic attraction force at low cost.

Next, the configuration of the fuel injection valve 1 according to the embodiment of the invention will be described in detail with reference to FIGS. 1 to 5.

First, the operation of the fuel injection valve 1 will be described with reference to FIGS. 1 and 2. The nozzle holder 101 includes a small-diameter cylindrical portion 22 having a small diameter and the movable element storage portion 23 having a large diameter. The injection hole cup 116 having a guide portion 115 and a fuel injection hole 117 is inserted or press-fitted into the distal end of the small-diameter cylindrical portion 22, and all the outer peripheral edge of the injection hole cup 116 is welded. Thus, the injection hole cup 116 is fixed to the small-diameter cylindrical portion 22. The guide portion 115 has a function of guiding the outer periphery when a valve body tip portion 114B provided at the tip of the needle valve 114A of the movable element member 114 moves up and down in the axial direction of the fuel injection valve 1.

The conical valve seat portion 39 is formed in the injection hole cup 116 on the downstream side of the guide portion 115. The valve body tip portion 114B provided at the tip of the needle valve 114A contacts or separates from the valve seat portion 39, thereby blocking the flow of fuel or guiding the fuel to the fuel injection hole. A groove is formed on the outer periphery of the nozzle holder 101, and a combustion gas seal member typified by a resin-made chip seal 131 is fitted into the groove.

A needle valve guide portion 113 that guides the needle valve 114A of the movable element 102 is provided at the inner peripheral lower end portion of the fixed core 107. The needle valve 114A is provided with a guide portion 127, and the guide portion 127 is partially provided with a chamfered part to form the fuel passage. The elongated needle valve 114A is defined at a radial position by the needle valve guide portion 113 and is guided to reciprocate straight in the axial direction. Further, a valve opening direction is an upward direction of the valve shaft, and a valve closing direction is a downward direction of the axial direction of the valve.

A head 114C of a stepped portion 129 having an outer diameter larger than the diameter of the needle valve 114A is provided at the end opposite to the end where the valve body tip portion 114B of the needle valve 114A is provided. A seating surface of the spring 110 that urges the needle valve 114A in the valve closing direction is provided on the upper end surface of the stepped portion 129, and holds the spring 110 together with the head 114C.

The movable element member 114 includes the movable element 102 provided with a through hole 128 through which the needle valve 114A passes. A zero spring (movable spring) 112 that urges the movable element 102 between the movable element 102 and the needle valve guide portion 113 in the valve opening direction is held in the spring storage portion 112A.

Since the diameter of the through hole 128 is smaller than the diameter of the stepped portion 129 of the head 114C, the upper side surface of the movable element 102 held by the zero spring 112 and the lower end surface of the stepped portion 129 of the needle valve 114A are in contact with each other, and both are engaged under the biasing force of the spring 110 that presses the needle valve 114A toward the valve seat of the injection hole cup 116 or the gravity.

As a result, the upper end surface and the lower end surface cooperate with each other with respect to the upward movement of the movable element 102 against the urging force of the zero spring 112 or the gravity, or the downward movement of the needle valve 114A along the urging force of the zero spring 112 or the gravity. However, when the force to move the needle valve 114A upward or the force to move the movable element 102 downward both act independently on the upper and lower end surfaces regardless of the urging force or the gravity of the zero spring 112, the both surfaces may move in different directions.

The fixed core 107 is press-fitted into the inner peripheral portion of the movable element storage portion 23 of the nozzle holder 101 and welded at a press-fitting contact position (the butt welded portion 403). The gap formed between the inner portion of the movable element storage portion 23 of the nozzle holder 101 and the ambient air is sealed by the welding. In the center of the fixed core 107, a through hole 107D having a diameter pCn is provided as a fuel introduction passage.

In other words, the lower surface (downstream surface) of the fixed core 107 and the upper surface (upstream surface) of the mounting portion 401 of the nozzle holder 101 directly abut and are press-fitted, so the fixed core 107 and the nozzle holder 101 are fixed.

The lower end surface of the fixed core 107, and the upper end surface and the collision end surface of the movable element 102 may be plated to improve durability. Even in a case where soft magnetic stainless steel is used for the movable element 102, durability and reliability can be secured by using hard chromium plating or electroless nickel plating.

The lower end of the initial load setting spring 110 is in contact with a spring receiving surface formed on the upper end surface of the stepped portion 129 provided on the head 114C of the needle valve 114A. The other end of the spring 110 is stopped by an adjuster 54. With this configuration, the spring 110 is held between the head 114C and the adjuster 54. The initial load with which the spring 110 presses the needle valve 114A against the valve seat portion 39 can be adjusted by adjusting the fixing position of the adjuster 54.

The cup-shaped housing 103 is fixed to the outer periphery of the movable element storage portion 23 of the nozzle holder 101. A through hole is provided in the center of the bottom of the housing 103, and the movable element storage portion 23 of the nozzle holder 101 is inserted through the through hole.

The electromagnetic coil 105 wound in an annular shape is disposed in a cylindrical space formed by the housing 103. The electromagnetic coil 105 is formed of an annular coil bobbin 104 of which the cross section is a U-shaped groove opening outward in the radial direction, and a copper wire wound in the groove. A rigid conductor 109 is fixed at the start and end of winding of the electromagnetic coil 105 and is drawn out from a through hole provided in the fixed core 107.

The conductor 109, the fixed core 107, and the outer periphery of the movable element storage portion 23 of the nozzle holder 101 are molded by injecting an insulating resin from the inner periphery of the upper end opening of the housing 103, and covered with the resin molded body 121. Thus, a toroidal magnetic passage is formed around the electromagnetic coil 105.

A plug for supplying power from a high voltage power source and a battery power source is connected to a connector 43A formed at the distal end of the conductor 109, and energization/non-energization is controlled by the fuel injection control device 2. While the electromagnetic coil 105 is energized, a magnetic attraction force is generated between the movable element 102 of the movable element member 114 and the fixed core 107 in a magnetic attractive gap by the magnetic flux passing through a magnetic circuit 140M, and the movable element 102 is sucked by a force exceeding a set load of the spring 110 so as to move upward.

At this time, the movable element 102 engages with the head 114C of the needle valve 114A, moves upward together with the needle valve 114A, and moves until the upper end surface of the movable element 102 collides with the lower end surface of the fixed core 107. As a result, the valve body tip portion 114B at the tip of the needle valve 114A is separated from the valve seat portion 39. The fuel passes through the fuel passage and is ejected from the fuel injection hole 117 at the tip of the injection hole cup 116 into the combustion chamber of the internal combustion engine.

While the valve body tip portion 114B at the tip of the needle valve 114A is separated from the valve seat portion 39 and pulled upward, the elongated needle valve 114A is guided to return straight along the axial direction of the valve by two places, a needle valve guide portion 113 and the guide portion 115 of the injection hole cup 116.

When the energization of the electromagnetic coil 105 is cut off, the magnetic flux disappears and the magnetic attraction force in the magnetic attractive gap disappears. In this state, the spring force of the initial load setting spring 110 that pushes the head 114C of the needle valve 114A in the opposite direction overcomes the force of the zero spring 112, and acts on the entire movable element member 114 (the movable element 102, the needle valve 114A). As a result, the movable element 102 is pushed back by the spring force of the spring 110 to the valve closing position where the valve body tip portion 114B abuts on the valve seat portion 39.

While the valve body tip portion 114B at the tip of the needle valve 114A is in contact with the valve seat portion 39 and is at the valve closing position, the elongated needle valve 114A is guided only by the needle valve guide portion 113, and does not abut on the guide portion 115 of the injection hole cup 116.

At this time, the stepped portion 129 of the head 114C abuts on the upper surface of the movable element 102 and overcomes the force of the zero spring 112 to move the movable element 102 toward the needle valve guide portion 113 side. When the valve body tip portion 114B collides with the valve seat portion 39, the movable element 102 is separated from the needle valve 114A, and therefore continues to move in the direction of the needle valve guide portion 113 due to inertial force. At this time, friction due to fluid occurs between the outer periphery of the needle valve 114A and the inner periphery of the movable element 102, and the energy of the needle valve 114A that rebounds from the valve seat portion 39 in the valve opening direction is absorbed.

Since the movable element 102 of a large inertial mass is separated from the needle valve 114A, the rebound energy itself is reduced. Further, the movable element 102 absorbed the rebound energy of the needle valve 114A reduces in inertial force by that amount, and the repulsive force received after compressing the zero spring 112 is also reduced. Therefore, a phenomenon that the needle valve 114A is moved again in the valve opening direction is less likely to occur by the rebounding phenomenon of the movable element 102. Thus, the rebounding of the needle valve 114A is minimized, and it is suppressed a so-called secondary injection phenomenon in which the valve opens after the energization to the electromagnetic coil 105 is cut off and the fuel is randomly injected.

As illustrated in FIG. 2, since the magnetic throttle part 150 is thinner than its peripheral portion, a precipitation hardening stainless steel is selected as a material of the nozzle holder 101 with priority on strength. Using the selected material with priority on strength, it can withstand the stress generated at a fuel pressure of 35 MPa. Since the fixed core 107 forms a magnetic circuit, there is no thin portion. Therefore, a material having excellent magnetism is selected for the fixed core 107. Because of the large thickness, it can withstand the stress generated at a fuel pressure of 35 MPa even when a low-strength material is selected.

The mounting portion 401 of the nozzle holder 101 of the fuel injection valve 1 and the mounting portion 402 of the fixed core 107 are in radial contact with each other, press-fitted, and butt-welded by the butt welded portion 403 to seal the fuel. Since the mounting portion 401 of the nozzle holder 101 and the mounting portion 402 of the fixed core 107 are press-fitted and fixed before welding, the nozzle holder 101 can be prevented from being tilted due to distortion generated during welding.

Thereby, the butt welding of the mounting portion 402 and the mounting portion 401 is enabled, and both can be manufactured and fixed firmly at low cost. Since the material used for the nozzle holder 101 is stronger than the fixed core 107, it makes sense to arrange the material on the outer peripheral side where stress is high. In addition, the material of a high strength has an advantage that it can be thinned and can be easily welded.

Next, a method for manufacturing the fuel injection valve 1 according to this embodiment will be described.

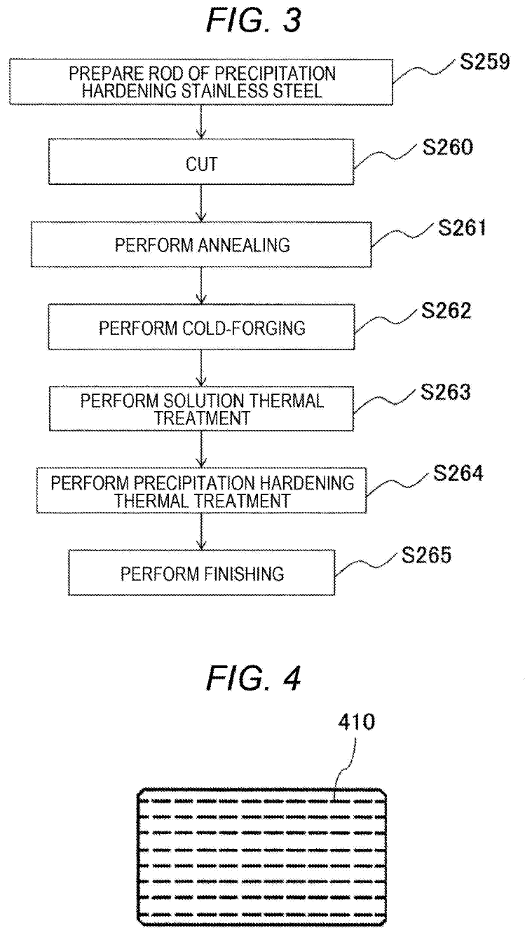

First, each component including the nozzle holder 101 described with reference to FIGS. 1 and 2 of the fuel injection valve 1 (the fixed core 107 facing the upper end portion of the movable element 102, the electromagnetic coil 105 disposed on the outer peripheral side of the fixed core 107, a needle valve 114A engaged with the movable element 102) are prepared. Among the components of the fuel injection valve 1, components other than the nozzle holder 101 can be prepared according to their specifications by various known methods. The nozzle holder 101 is manufactured by a manufacturing method illustrated in FIG. 3 described below. Details will be described later.

Next, the components including the prepared nozzle holder 101 are assembled, subjected to appropriate inspection as a finished product, and move to a procedure of being assembled to the fuel injection valve 1.

Next, a method for manufacturing the nozzle holder 101 according to this embodiment will be described with reference to FIGS. 3 and 10.

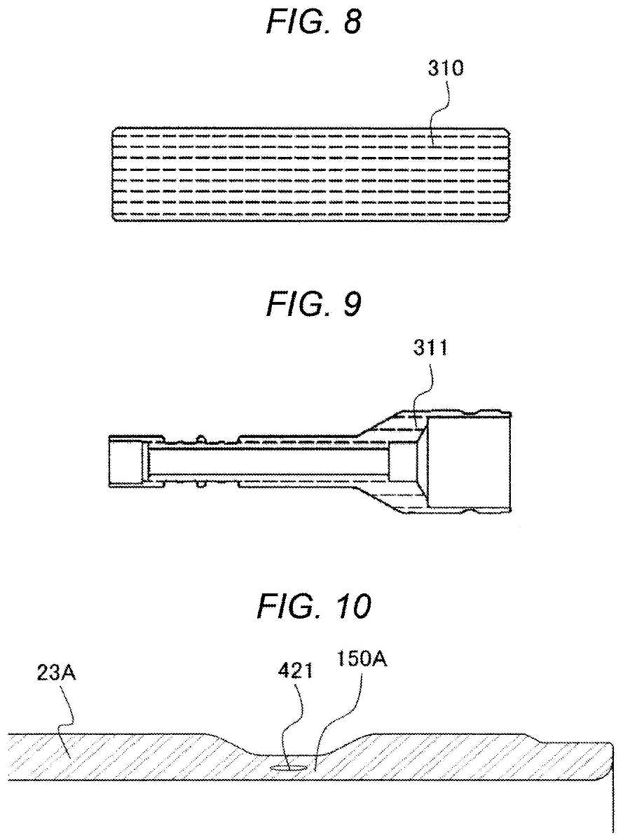

FIG. 3 is a flowchart illustrating an example of the manufacturing procedure of the nozzle holder 101 in the method for manufacturing the fuel injection valve 1 in this embodiment. FIGS. 4 to 6 are diagrams illustrating cross-sectional views and forged lines in the manufacturing procedure of the nozzle holder of the fuel injection valve 1 according to this embodiment. FIG. 7 is an enlarged cross-sectional view of the magnetic throttle part 150 of the nozzle holder of the fuel injection valve 1 according to this embodiment. FIGS. 8 and 9 are diagrams illustrating cross-sectional views and forged lines in the manufacturing procedure of the nozzle holder of the fuel injection valve 1 according to another aspect of this embodiment. FIG. 10 is an enlarged cross-sectional view of the magnetic throttle part 150 of the nozzle holder of the fuel injection valve 1 according to another aspect of this embodiment.

As illustrated in FIG. 3, first, as a material of the nozzle holder 101, a rod material made of stainless steel equivalent to JIS-SUS630 (17-4PH, etc.), which is a precipitation hardening stainless steel, or a rod made of stainless steel equivalent to JIS-SUS631 (17-7PH, etc.) is prepared (Step S259). In the following, the description will be given about an example in a case where SUS630 is used.

In this way, with the use of any one of SUS630, SUS631, 17-4PH, and 17-7PH as the precipitation hardening stainless steel, it is possible to suppress an increase in the material cost of the nozzle holder 101, and the fuel injection valve 1 can be provided at a low cost.

Next, as illustrated in FIG. 4, the material supplied by the rod material is cut into a predetermined length (Step S260). The broken line in FIG. 4 indicates a forged line 410. In the manufacturing procedure of the rod material, the lump of stainless steel is gradually stretched in the longitudinal direction of the rod material, and thus forms the forged line 410 in the direction illustrated in FIG. 4. It is generally known that a very small amount of inclusions usually contained in metal also exists along the forged line 410.

Next, annealing is performed (Step S261). The annealing condition includes, for example, 830° C.×90 minutes, rapid cooling, etc., but this is an example because the condition depends on the material.

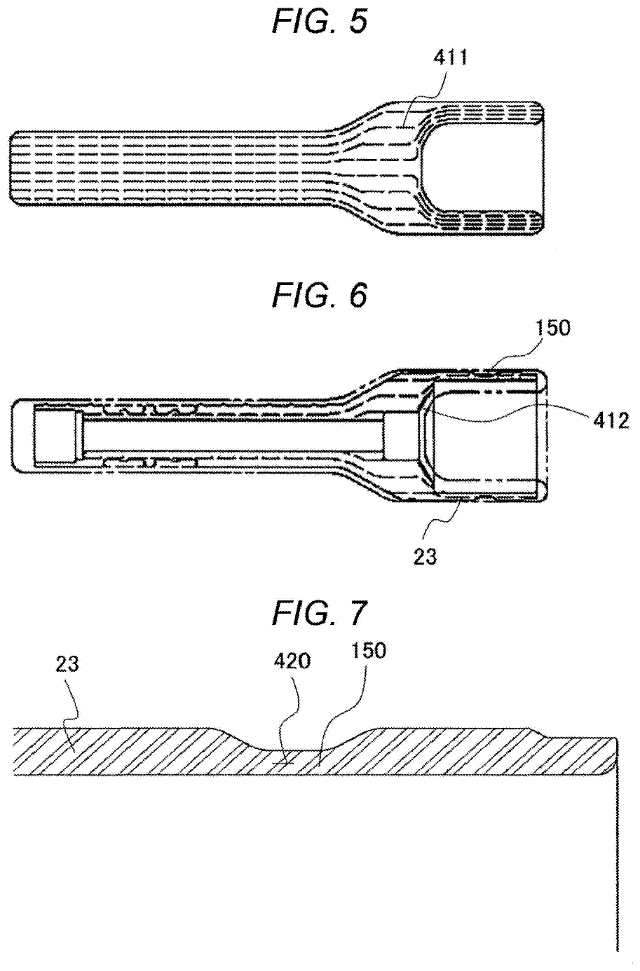

Thereafter, cold forging is performed on the precipitation hardening stainless steel rod after annealing (Step S262), and plastic machining is performed into a blank shape as illustrated in FIG. 5. The shape at that time is characterized by cold-forging along the shapes of the movable element storage portion 23 and the magnetic throttle part 150. By cold-forging the material in a shape along the movable element storage portion 23 and the magnetic throttle part 150, the forged line 411 in the material is also formed in a shape along the outer periphery of the movable element storage portion 23 and the magnetic throttle part 150 as illustrated in FIG. 5.

Thereafter, a solution thermal treatment (for example, 1020±−5° C. rapid cooling) is performed (Step S263), and an element (for example, a copper element) precipitated by annealing before cold forging is solidified again. Further, since the solution thermal treatment is performed up to, for example, about 1020° C., there is an effect of alleviating the distortion of the metal structure during cold forging. In particular, since the movable element storage portion 23 serves as a magnetic path between the housing 103 and the movable element 102, the magnetic properties can be improved by this solution thermal treatment.

Thereafter, precipitation hardening thermal treatment (for example, 580±10° C. air cooling) is performed (Step S264) to precipitate the elements and improve the strength.

Finally, all the parts of the nozzle holder 101 including the magnetic throttle part 150 are finished (Step S265). In this finishing, the magnetic throttle part 150 is finally molded by cutting. In addition, the spring storage portion 112A of the nozzle holder 101 is molded, and a space for inserting the needle valve 114A and the injection hole cup 116 is molded by cutting. Further, a groove for holding the chip seal 131 is molded by cutting.

In this way, the finishing is performed after all thermal treatment to avoid the effect of distortion due to thermal treatment, and the shape and thickness of the press-fitting part and magnetic throttle part 150 with other components that require high-precision dimensions can be finished with good accuracy.

In addition, in this finishing and molding, the magnetic throttle part 150 can be molded with higher accuracy by molding the magnetic throttle part 150 by cutting.

Furthermore, in the finishing and molding, the movable element 102 is highly accurately biased in the direction of the fixed core 107 by molding the spring storage portion 112A for storing the zero spring 112 that biases the movable element 102 in the direction of the fixed core 107. The valve opening accuracy can be further improved.

By the forging in Step S262 and the finishing in Step S265, as illustrated in FIG. 6, the nozzle holder 101 is formed with a forged line 412 in the radial direction along the bottom surface in a portion of the bottom surface of the movable element storage portion 23 that holds the movable element 102. In addition, inclusions that may exist along the forged line 412 are highly likely to close inside the finished nozzle holder 101 similarly to the forged line 412. It is possible to extremely reduce a risk that the outside is connected to the inside where the high-pressure fuel exists.

Furthermore, inclusions that may exist in the magnetic throttle part 150 are crushed in the longitudinal direction of the nozzle holder 101 by forging as illustrated by inclusions 420 in FIG. 7. It is possible to reduce a risk that the inclusions 420 appear on the surface after finishing.

With the above effects, it is possible to provide the nozzle holder 101 for the fuel injection valve 1 capable of realizing high strength and high magnetic attraction force at low cost.

FIGS. 8 and 9 illustrate the procedures in the case of cutting the nozzle holder 101 from a rod by cutting as a comparative example in a case where particularly cold forging and only cutting are performed. In a case where the finished product of the nozzle holder 101 is cut off from a rod, the forged line 310 when supplied with the rod illustrated in FIG. becomes the forged line 311 passing through inside and outside as illustrated in FIG. 9. Further, as illustrated in FIG. 10, since the inclusion 421 is not crushed, there is a strong possibility that the inclusion is exposed to the surfaces of a movable element storage portion 23A and a magnetic throttle part 150A compared to the case illustrated in FIGS. 4 to 7. Therefore, it is necessary to check that such inclusions do not exist by various inspections. There is a possibility that the effect of reducing the inspection cost compared to the related art may be reduced compared to the case illustrated in FIGS. 4 to 7.

### <Others>

Further, this invention is not limited to the above embodiments, and various modifications and applications may be possible. The above-described embodiments have been described in detail for clear understating of the invention, and are not necessarily limited to those having all the described configurations.

For example, in the above embodiment, the description has been given about that the forging in Step S262 in FIG. 3 is cold forging, but the forging in Step S262 in FIG. 3 may be hot forging instead of cold forging. However, with the use of the cold forging, it is possible to perform forging at a low cost compared to the hot forging, and it is possible to provide the fuel injection valve 1 at a low cost. Therefore, it is desirable to use the cold forging.

In addition, the fuel injection valve 1 of the type that opens and closes the fuel passage by the electromagnetically driven movable element 102 has been described as an example. However, the invention may be applied to a fuel injection valve of the type that uses a piezoelectric element (piezo element) as the fuel injection valve. In a case where the nozzle holder of such a piezoelectric element type fuel injection valve is used, the magnetic throttle part 150 is not necessary.

### REFERENCE SIGNS LIST

1 fuel injection valve
23, 23A movable element storage portion
101 nozzle holder (metal member)
102 movable element
105 electromagnetic coil
107 fixed core
107D through hole (fuel passage)
110 spring
112 zero spring
112A spring storage portion
114A needle valve
140M magnetic circuit
150, 150A magnetic throttle part
403 butt welded portion
310, 311, 410, 411, 412 forged line
420, 421 inclusion

1. A flow volume control device comprising:
a movable element; and
a metal member that is positioned on an outer peripheral side of the movable element and holds the movable element inside in a radial direction,
wherein the metal member is molded using a precipitation hardening stainless steel as a material.

2. The flow volume control device according to claim 1, further comprising:
a fixed core that is disposed to face the movable element,
wherein the metal member includes a magnetic throttle part formed on an outer peripheral side of an intermediate portion between the movable element and the fixed core.

3. The flow volume control device according to claim 1, wherein the metal member is made using any one of SUS630, SUS631, 17-4PH, and 17-7PH as the precipitation hardening stainless steel.

4. The flow volume control device according to claim 1,
wherein the metal member is made such that a forged line is formed in a radial direction along a bottom surface in a portion of the bottom surface of a movable element storage portion that holds the movable element.

5. The flow volume control device according to claim 1, further comprising:
a fixed core that faces an upper end portion of the movable element;
a solenoid that is disposed on an outer peripheral side of the fixed core; and
a valve body that is engaged with the movable element,
wherein a magnetic attraction force is generated by energizing the solenoid to attract the movable element toward the fixed core and open the valve body.

6. A method for manufacturing a flow volume control device that includes a movable element and a metal member that is positioned on an outer peripheral side of the movable element and holds the movable element inside in a radial direction, the method comprising:
forging and molding a material using a precipitation hardening stainless steel as a material of the metal member;
performing solution thermal treatment on the material after the forging and molding;
performing precipitation hardening thermal treatment on the material after the solution thermal treatment; and
finishing and molding the material after the precipitation hardening thermal treatment to form the metal member.

7. The method according to claim 6,
wherein the flow volume control device further includes a fixed core that is disposed to face the movable element,
wherein, in the forging and molding, a throttle portion for forming a magnetic throttle part is molded on an outer peripheral side of an intermediate portion between the movable element and the fixed core of the material.

8. The method according to claim 7,
wherein, in the finishing and molding, the magnetic throttle part is finally molded.

9. The method according to claim 6,
wherein the forging and molding is cold forging.

10. The method according to claim 6,
wherein one of SUS630, SUS631, 17-4PH, and 17-7PH is used as the material.

11. The method according to claim 8,
wherein, in the finishing and molding, the magnetic throttle part is molded by cutting.

12. The method according to claim 6,
wherein the metal member is made such that a forged line is formed in a radial direction along a bottom surface in a portion of the bottom surface of a movable element storage portion that holds the movable element.

13. The method according to claim 6,
wherein the flow volume control device further includes a fixed core that faces an upper end portion of the movable element, a solenoid that is disposed on an outer peripheral side of the fixed core, and a valve body that is engaged with the movable element, and
wherein a magnetic attraction force is generated by energizing the solenoid to attract the movable element toward the fixed core and open the valve body.

14. The method according to claim 13,
wherein, in the finishing and molding, a storage portion that stores a movable element spring that biases the movable element toward the fixed core is molded in the material.

15. The method according to claim 13,
wherein, after the finishing and molding, an outer peripheral portion of the fixed core and an inner peripheral portion of a cylindrical portion of the metal member are bonded.
